(19) United States
(12) Patent Application Publication
(10) Pub. No.: US 2024/0146065 A1
(43) Pub. Date: May 2, 2024

(54) METHOD FOR CONTROLLING AN ELECTRIC MICROGRID

(71) Applicants: Centre national de la recherche scientifique, PARIS (FR); Université de Lille, LILLE (FR); ECOLE POLYTECHNIQUE, PALAISEAU (FR); TotalEnergies OneTech, LILLE (FR)

(72) Inventors: Gonzague HENRI, OAKLAND, CA (US); Philippe CORDIER, PARIS (FR); Tanguy LEVENT, PARIS (FR); Philippe PREUX, VILLENEUVE D'ASCQ (FR); Yves BONNASSIEUX, PARIS (FR)

(73) Assignees: Centre national de la recherche scientifique, PARIS (FR); Université de Lille, LILLE (FR); ECOLE POLYTECHNIQUE, PALAISEAU (FR); TotalEnergies OneTech, COURBEVOIE (FR)

(21) Appl. No.: 18/269,545

(22) PCT Filed: Dec. 23, 2021
(86) PCT No.: PCT/EP2021/087590

§ 371 Date: Jun. 23, 2023

(30) Foreign Application Priority Data
Dec. 24, 2020 (FR) FR2014141

(51) Int. Cl. H02J 3/32; H02J 3/38

(52) U.S. Cl. CPC H02J 3/32; H02J 3/381; H02J 3/388; H02J 2203/10; H02J 2203/20; H02J 2300/10; H02J 2300/20; H02J 2300/40

(57) ABSTRACT

A method for controlling an electric microgrid comprising an electrical energy consuming element, an electrical energy production element and an electrical energy storage element, the method comprising the steps of extracting parameter values from a source model, the extraction phase being implemented by computer, initializing parameters of a target model with parameter values extracted from the source model, so as to obtain an initialized target model, the initialization phase being implemented by computer, and optimizing, according to a target domain and a target set of tasks, of the parameters of the initialized target model, so as to obtain a target model trained for the control of a target microgrid, the optimization phase being implemented by computer.

### CROSS REFERENCE TO RELATED APPLICATIONS

The present application is a U.S. National Phase application under 35 U.S.C. § 371 of International Patent Application No. PCT/EP2021/087590 filed Dec. 23, 2021, which claims priority of French Patent Application No. 2014141 filed Dec. 24, 2020. The entire contents of which are hereby incorporated by reference.

### FIELD OF THE INVENTION

The present invention relates to a method for controlling an electrical microgrid. The invention further relates to an associated computer program method with such method.

### BACKGROUND

One of the challenges of our century is to reduce greenhouse gas emissions. To meet such challenge, many investments relate to the development of renewable energies and distributed energy resources (DER). As renewable energy sources, such as solar and wind energy sources, have stochastic character, electricity grid infrastructures need to be adapted in order to maintain the reliability and the stability of the electricity grid.

To this end, microgrids used for the integration of renewable energy sources into electricity grids, have been developed. A microgrids is a power grid which includes renewable energy sources (wind turbines or photovoltaic panels), traditional fossil energy sources (diesel generator), energy storage devices (batteries), energy-consuming loads and an energy management system. A microgrid operates either connected to or disconnected from the main grid in isolated mode. A microgrid is also suitable for being completely disconnected from the main grid (off-network).

One of the elements making the operation of a microgrids possible, is the energy management system of the microgrid.

In particular, energy management systems are known, which are based on a prediction module over the next hours, of the power produced by the renewable energy sources (photovoltaic panels) and the consumption of loads. The different units of the grid are then managed according to an optimization method using the predictions of the module.

However, such a prediction module is not suitable for coping with changing and unforeseen conditions. Furthermore, same is complex to implement.

Other energy management systems based on machine learning (training models) have also been developed. Such systems are used for the control of microgrids for which same have been trained.

However, training such models is time-consuming and resource-intensive, making such solution complex to deploy on a large scale.

Still other means of managing microgrids are presented in the documents US 2017/194814 A and CON 112 117 760 A. The article M. Rawa et al., “An Efficient Scheme for Determining the Power Loss in Wind-PV Based on Deep Learning,” in IEEE Access, vol. 9, pp. 9481-9492, 2021, doi: 10.1109/ACCESS.2020.3046687 describes a method using deep learning for determining power losses in wind and solar energy systems.

There is thus a need for a tool which would facilitate the control of different microgrids, while eliminating the need for a prediction module.

### SUMMARY

To this end, the subject matter of the present description is a method for controlling at least one electrical microgrid, each electrical microgrid comprising at least one electrical energy consumption element, at least one electrical energy production element and at least one electrical energy storage element, each microgrid being suitable for assuming a plurality of energy states, each energy state being defined by a quantity of electrical energy to be exchanged between elements of the microgrid and by a quantity of electrical energy stored on the at least one electrical energy storage element, each microgrid being apt to switch from one state to another by the implementation of an action on the microgrid among a set of predefined actions, the method comprising the phases of:
a. supply of a model, called source model, trained on a source domain for learning a source set of tasks, so that the source model is apt to determine an action, among the set of predefined actions, of control of a given microgrid, called source microgrid, according to the state of the source microgrid, the source microgrid being suitable for operating in a given environment, called source environment, delimiting the source domain, the source microgrid being suitable for operating according to a given operating mode, called source operating mode, delimiting the source set of tasks, the source model comprising parameters the values of which are optimized for the source domain and the source set of tasks,
b. supply of a model, called target model, suitable for training on a target domain for learning a target set of tasks, so that the target model is suitable for determining an action, among the set of predefined actions, for controlling a given microgrid, called target microgrid, depending on the state of the target microgrid, the target microgrid being suitable for operating in a given environment, called target environment, delimiting the target domain, the target microgrid being suitable for operating in a given operating mode, called target operating mode, delimiting the target set of tasks, the target environment and the target operating mode being such that the target domain is different from the source domain and/or the target set of tasks is different from the source set of tasks, the target model comprising parameters,
c. extraction of parameter values from the source model, the extraction phase being implemented by computer,
d. Initialization of parameters of the target model with parameter values extracted from the source model, so as to obtain an initialized target model, the initialization phase being implemented by computer, and
e. optimization, according to the target domain and to the target set of tasks, of the parameters of the initialized target model, so as to obtain a target model trained for the control of the target microgrid, the optimization phase being implemented by computer.

According to other particular embodiments, the method comprises one or more of the following features, taken individually or according to all technically possible combinations:
at least one parameter value of the target model which has been initialized with the extracted values is frozen during the optimization step;
each model is a neural network comprising a layer of input neurons, a layer of output neurons and intermediate layers of neurons, the parameters of each model defining the synaptic weights between the neurons of consecutive layers, the parameter values extracted from the source model, corresponding at least to the synaptic weights between the neurons of the input layer and the neurons of the intermediate layer consecutive to the input layer, called first intermediate layer, and furthermore, preferentially, the synaptic weights between the neurons of a plurality of intermediate layers of neurons, consecutive to the first intermediate layer of neurons;
the optimization phase comprising:
   a. a step of generation of training datasets according to the target domain and to the target set of tasks,
   b. a step of training the target model wherein at least one parameter of the target model is optimized based on at least one training set generated for obtaining an optimized target model, and
   c. the repetition of the generation and training steps until a convergence criterion is satisfied, the target model optimized during the last iteration being a target model trained for the control of the target microgrid.
the method comprising:
   a. a phase of operating the trained target model comprising the determination of a control action of the target microgrid following the reception, by the trained target model, of the current state of the target microgrid, and
   b. a phase of performing the action determined by sending commands to the elements of the target microgrid.
the predefined operating modes comprising at least the following operating modes:
   a. a so-called isolated operating mode wherein the microgrid is disconnected from the electrical power distribution grid,
   b. a so-called connected operating mode wherein the microgrid is connected to an electrical power distribution grid, and
   c. a so-called intermediate operating mode wherein the microgrid is connected to an electrical energy distribution grid or is isolated from the electrical energy distribution grid depending on the time step considered.
each microgrid including at least one renewable energy production element and at least one fossil energy production element, the quantity of electric energy to be exchanged being the difference between the quantity of electric energy produced by the at least one renewable energy production element and the quantity of electric energy demanded by the at least one electric energy consumption element, the quantity of electrical energy to be exchanged being a quantity of electrical energy to be exchanged between the elements of the microgrid with the exception of the at least one renewable energy production element;
for two microgrids operating in distinct environments:
   a. the distribution of the quantity of electric power produced by the at least one renewable energy production element of one of the microgrids over a predetermined period being different from the distribution of the quantity of electric power produced by the at least one renewable energy production element of the other microgrid over the predetermined period, and/or
   b. the distribution of the quantity of electric power demanded by the at least one electric power consumption element of one of the microgrids over a predetermined period being different from the distribution of the quantity of electric power demanded by the at least one electric power consumption element of the other microgrid over the predetermined period of time;
the set of predefined actions comprising at least one of the following actions:
   a. the discharge of the at least one electrical energy storage element by a quantity corresponding to the quantity of electrical energy to be exchanged, or when the quantity of electrical energy stored on the at least one electrical energy storage element is insufficient with regard to the quantity of electrical energy to be exchanged, the full discharge of the at least one electrical energy storage element and the supply of the remaining quantity of electrical energy by the at least one electrical energy production element,
   b. the charge of the at least one electrical energy storage element of a value corresponding to the quantity of electrical energy to be exchanged,
   c. the production of a quantity of electrical energy corresponding to the quantity of electrical energy to be exchanged by the at least one electrical energy production element,
   d. the import of electrical energy from an electrical energy distribution grid, so as to supply at least part of the quantity of electrical energy to be exchanged,
   e. the export of at least part of the quantity of electrical energy to be exchanged to an electrical energy distribution grid,
   f. the import of the quantity of electrical energy to be exchanged from an electrical energy distribution grid and a quantity of electrical energy for charging the electrical energy storage element, and
   g. not taking any action.

The present description also relates to a computer program product comprising a readable storage medium, on which is stored a computer program comprising program instructions, the computer program being loadable on a data processing unit and implementing and suitable for leading to the implementation of the method such as described hereinabove when the computer program is implemented on the data processing unit.

The present description further relates to a readable information medium on which is stored a computer program product such as described hereinabove.

### BRIEF DESCRIPTION OF THE DRAWINGS

Other features and advantages of the invention will appear upon reading hereinafter the description of the embodiments of the invention, given only as an example, and making reference to the following drawings:

FIG. 1 is a schematic view of an example of microgrid,

FIG. 2, a schematic view of an example of a computer for implementing a method for controlling a microgrid,

FIG. 3, a flowchart of an example of implementation of a method for controlling a microgrid,

FIG. 4, a schematic representation of an example illustrating different layers of neurons in a neural network,

FIG. 5, a schematic representation of an example illustrating the extraction of parameter values from a source model for the initialization of parameters of a target model, and

FIG. 6, a schematic representation illustrating the implementation of a phase of optimization of the parameters of a target model.

### DETAILED DESCRIPTION

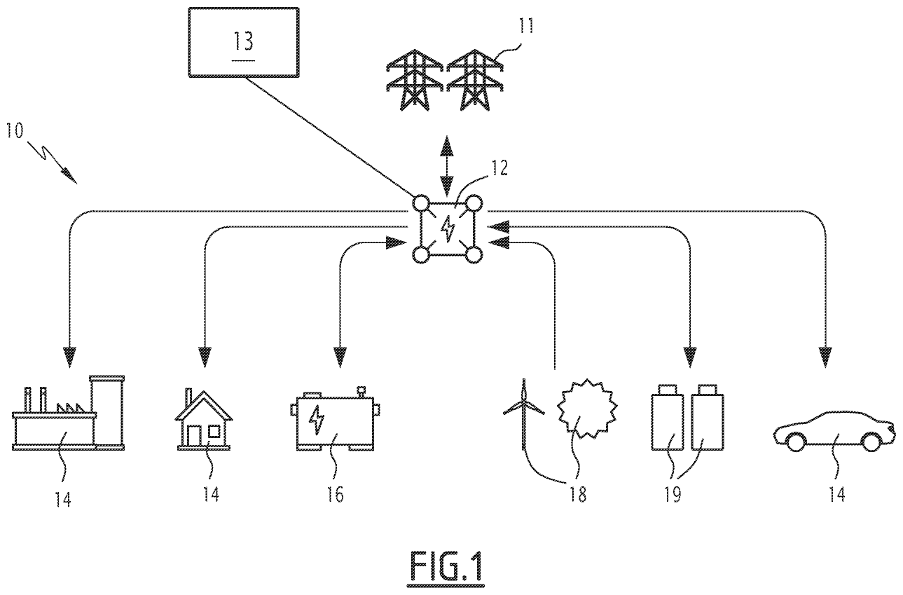

An example of microgrid 10 is illustrated in FIG. 1. In said example, the microgrid 10 can be connected to a main electrical grid 11. The microgrid 10 comprises an electrical energy transmission grid 12, elements suitable for being connected to the electrical energy transmission grid 12 and a tool 13 for controlling the microgrid 10. The elements of the microgrid 10 comprise at least one electrical energy consumption element 14, at least one fossil energy production element 16, at least one renewable energy production element 18 and at least one electrical energy storage element 19.

The microgrid 10 is apt to assume a plurality of energy states Sₜ. Each energy state Sₜ is defined by a quantity of electrical energy to be exchanged P_{Net} between elements of the microgrid 10 and by a quantity of electrical energy stored E_{BCap} on the at least one electrical energy storage element 19.

For example, the quantity of electric energy to be exchanged P_{Net} is the difference between the quantity of electric energy produced P_{PV} by the at least one renewable energy production element 18 and the quantity of electric energy demanded P_{C} by the at least one electric energy consumption element 14. The quantity of electrical energy to be exchanged P_{Net} is, in such case, a quantity of electrical energy to be exchanged between the elements of the microgrid 10 with the exception of the at least one renewable energy production element 18.

The microgrid 10 is apt to switch from one state Sₜ to another by implementing an action Aₜ on the microgrid 10 from a set E_{A} of predefined actions.

For example, set E_{A} of predefined actions includes at least one of the following actions:
A₁: the discharge of at least one electrical energy storage element 19 by a value corresponding to the quantity of electrical energy to be exchanged P_{Net}, or, when the quantity of electrical energy stored E_{BCIP} on the at least one electrical energy storage element 19 is insufficient compared to the quantity of electrical energy to be exchanged P_{Net}, the full discharge of the at least one electrical energy storage element 19 and the supply of the remaining quantity of electrical energy by the at least one electrical energy production element 16,
A₂: the charging of at least one electrical energy storage element 19 by a value corresponding to the quantity of electrical energy to be exchanged P_{Net},
A₃: the production of a quantity of electrical energy corresponding to the quantity of electrical energy to be exchanged P_{Net} by the at least one electrical energy production element 16,
A₄: the import of electrical energy from an electrical energy distribution grid, so as to supply at least part of the quantity of the electrical energy to be exchanged P_{Net},
A₅: the export of at least a part of the quantity of electrical energy to be exchanged P_{Net} to an electrical energy distribution grid,
A₆: the import of the quantity of electrical energy to be exchanged P_{Net} from an electrical energy distribution grid and of a quantity of electrical energy (e.g. broadly speaking, between 10 percent and 20 percent), for charging the electrical energy storage element, and
A₇: not taking any action.

The microgrid 10 is suitable for operating in a given environment, among a set of predefined environments. The environment is e.g. a given geographical area.

The environment influences in particular the quantity of electrical energy to be exchanged P_{Net}. E.g. the environment influences at least one of the quantities of electric energy produced P_{PV} by the at least one renewable energy production element 18 and the quantity of electric energy demanded P_{C} by the at least one electric energy consumption element 14.

A predefined environment refers e.g. to a set of environments having similar profiles in terms of the quantity of electrical energy P_{PV} produced by the at least one renewable energy production element 18 and the quantity of electrical energy P_{C} demanded by the at least one electrical energy consumption element 14.

For example, for two 10 microgrids operating in distinct environments:
the distribution of the quantity of electrical energy P_{PV} produced by the at least one renewable energy production element 18 of one of the microgrids 10 over a predetermined period (example: one year) being different from the distribution of the quantity of electric energy P_{PV} produced by the at least one renewable energy production element 18 of the other microgrid 10 over the predetermined period, and/or
the distribution of the quantity of electrical energy P_{C} demanded by the at least one electrical energy consumption element 14 of one of the microgrids 10 over a predetermined period (example: one year) being different from the distribution of the quantity of electrical energy P_{C} demanded by the at least one electrical energy consumption element 14 of the other microgrid 10 over the predetermined period.

The microgrid 10 is suitable for operating according to a given operating mode, among a set of predefined operating modes. The operating mode advantageously relates to whether or not the microgrid 10 is connected to an electrical power distribution grid (main electrical grid). The operating mode of a microgrid 10 defines in particular the actions Aₜ suitable for being implemented on the microgrid 10 among the set E_{A} of predefined actions.

Advantageously, the predefined operating modes comprise at least one of the following operating modes, preferentially the following three operating modes:
a so-called isolated operating mode wherein the microgrid 10 is disconnected from an electrical power distribution grid (off-grid),
a so-called connected operating mode wherein the microgrid 10 is connected to an electrical energy distribution grid (the microgrid 10 is thus apt to exchange electrical energy with the electrical energy distribution grid), and
a so-called intermediate operating mode wherein the microgrid 10 is either connected to or isolated from an electrical power distribution grid depending on the time step considered (e.g. environments where the connection to the electrical power distribution grid is unstable or when the operators of the electrical power distribution grid decide not to interact with such and such microgrid for reasons of overall stability of the electrical power distribution grid).

In particular, for the isolated mode or the intermediate mode operating in isolation, the actions A₄, A₅ and A₆ are not possible because the microgrid 10 is not connected to an electrical power distribution grid. On the other hand, for the connected mode or the intermediate mode operating in connected mode, all the actions A₁ to A₇ are possible.

The electric power transmission grid 12 is configured for receiving the electric power produced or stored by the elements connected to said electric power transmission grid 12 and for distributing the received electric power to the elements connected to said electric power transmission grid 12.

The connection between each element and the electrical energy transmission grid 12 is e.g. established by a “machine to machine” protocol.

Each element of the microgrid 10 is suitable for being connected or disconnected from the electrical power transmission grid 12.

An electrical energy consumption element 14 is an element apt to consume electrical energy. An electrical energy consumption element 14 is e.g. an electrical lighting or heating network of a commercial or residential building, an electric vehicle, or further operational equipment.

A fossil energy production element 16 is an element apt to produce fossil energy. Fossil energy is produced from the sedimentary decomposition of organic matter, i.e. composed mainly of carbon. A fossil energy production element 16 uses primary resources such as oil, natural gas or coal. A fossil energy production element 16 is e.g. a coal power plant, a fuel oil power plant, a gas power plant or a diesel generator.

A renewable energy production element 18 is an element apt to produce renewable energy. A renewable energy is a source of energy coming from cyclic or constant natural phenomena induced e.g. by the stars: the Sun mainly for the heat and light the Sun generates, but also the attraction of the moon (tides) and the heat generated by the Earth (geothermal). A renewable energy production element 18 is e.g. a hydroelectric dam, a hydroelectric power plant, a set of wind turbines or a set of solar panels.

An electrical energy storage element 19 is an element apt to store electrical energy. An electrical energy storage element 19 is e.g. an electrical energy accumulator such as a battery. An electrical energy storage element 19 works as a generator of electrical energy when discharging, and as a consumer of electrical energy when charging.

The tool 13 is configured for controlling the quantities of electrical energy exchanged between the elements of the microgrid 10.

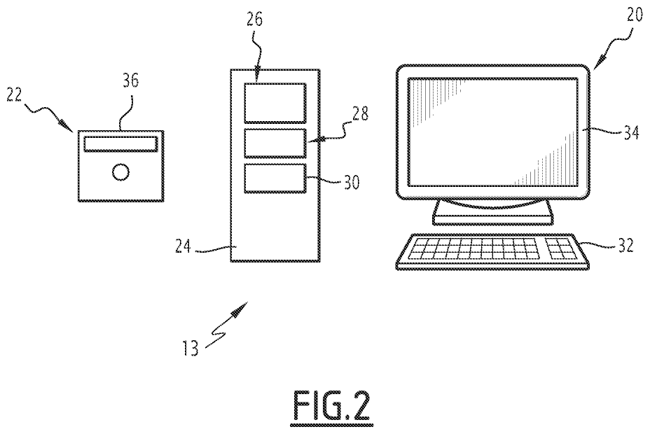

In the example illustrated in FIG. 2, the tool 13 comprises a calculator 20 and a computer program product 22.

The calculator 20 is preferentially a computer.

More generally, the calculator 20 is an electronic calculator suitable for manipulating and/or transforming data represented as electronic or physical quantities in registers of the calculator 10 and/or memories into other similar data corresponding to physical data in memories, registers or other types of display, transmission or storage.

The calculator 20 interacts with the computer program product 22.

As shown in FIG. 2, the calculator 20 includes a processor 24 comprising a data processing unit 26, memories 28 and a data storage medium 30. In the example illustrated in FIG. 2, the calculator 20 comprises a human-machine interface 32, such as screen, and a display 34.

The computer program product 22 includes a storage medium 36.

The storage medium 36 is a medium readable by the calculator 20, usually by the data processing unit 26. The readable storage medium 36 is a medium suitable for storing electronic instructions and apt to be coupled to a bus of a computer system.

As an example, the storage medium 36 is a USB key, a diskette or a floppy disk, an optical disk, a CD-ROM, a magneto-optical disk, a ROM, a RAM, an EPROM, an EEPROM, a magnetic card or an optical card.

The computer program 12 containing program instructions is stored on the storage medium 36.

The computer program 22 can be loaded into the data processing unit 26 and is suitable for the implementation of a method for controlling the microgrid 10 when the computer program 22 is implemented on the processing unit 26 of the calculator 20. Such a control method will be described hereinafter in the description.

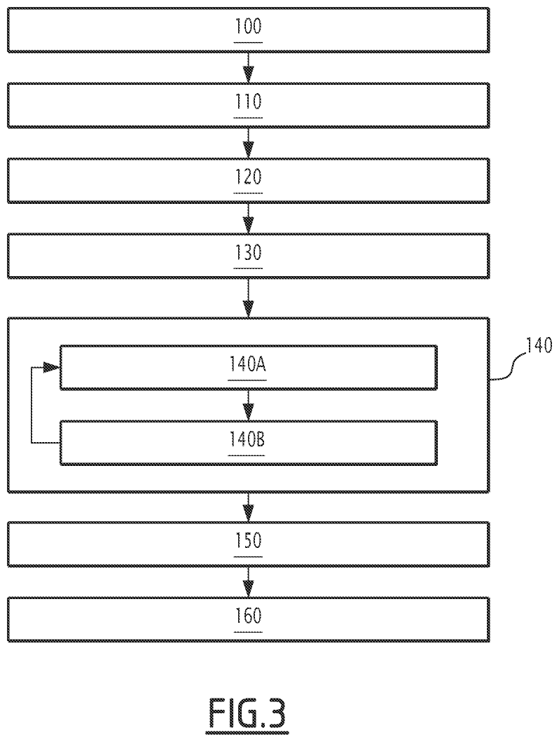

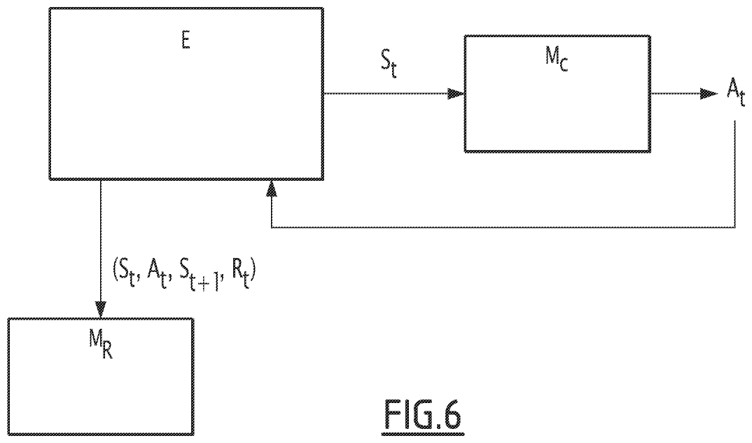

The operation of the control tool 13, i.e. of the calculator 20 in interaction with the computer program product 22 will now be described with reference to FIGS. 3 and 6, which schematically illustrate an example of the implementation of a method for controlling a microgrid 10.

The control method comprises a phase 100 of providing a model, called source model M_{S}, trained on a source domain D_{S} for learning a source set of tasks T_{S} aimed at controlling a given microgrid, called source microgrid 10S. The term “domain” refers to a space of input characteristics and a marginal probability distribution. The term “task set” refers to an output feature space and an objective prediction function.

More particularly, the source model M_{S} was trained for determining an action, among the set E_{A} of predefined actions (e.g. described hereinabove), for controlling the source microgrid 10S, depending on the state Sₜ of the source microgrid 10S.

The source microgrid 10S is suitable for operating in a given environment, called source environment E_{S}, and according to a given operating mode, called source operating mode F_{S}. The source environment E_{S} delimits the source domain D_{S}. The source operating mode F_{S} delimits the source set of tasks T_{S}.

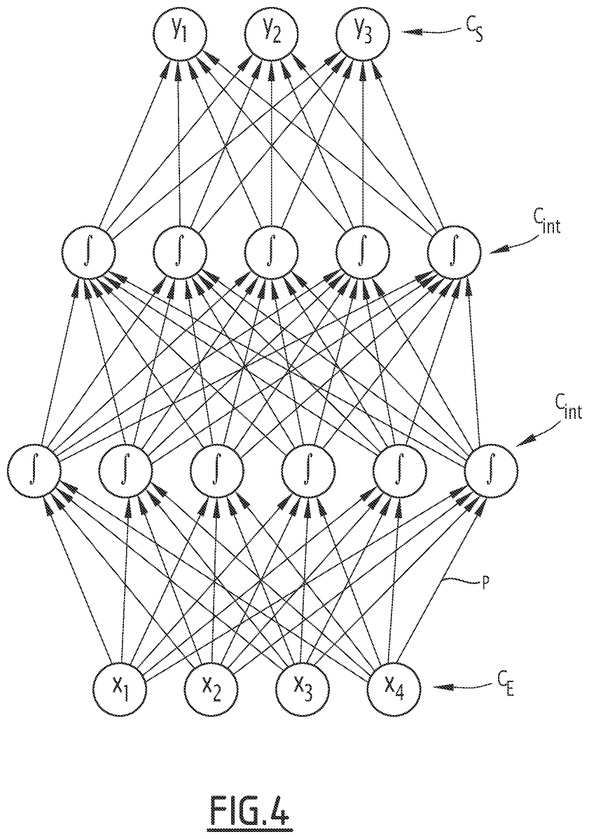

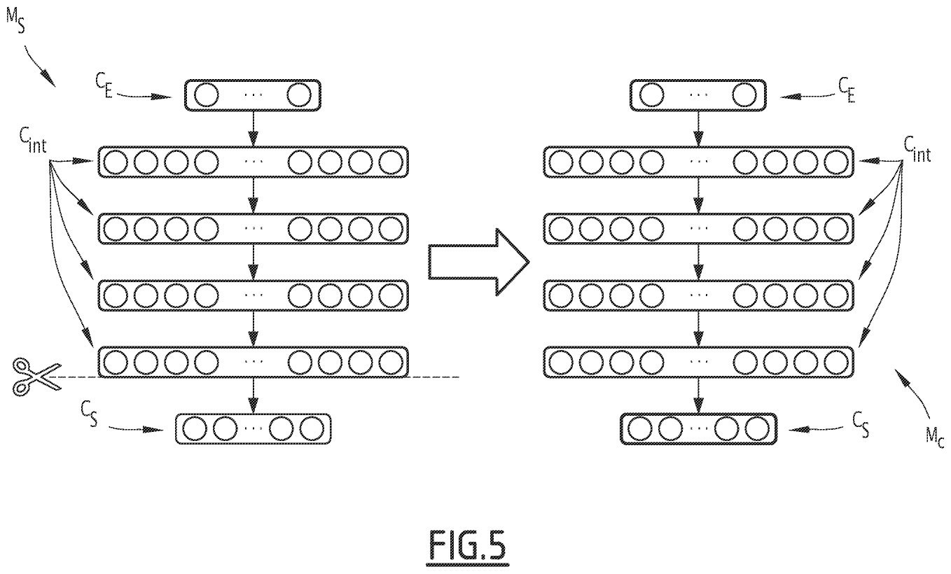

The source model M_{S} comprises in particular, parameters w the values of which are optimized for the source domain D_{S} and the source set of tasks T_{S}. In one example, the source model M_{S} is a neural network comprising an input neural layer C_{E}, an output neural layer C_{S} and intermediate neural layers Cᵢₙₜ. The parameters w of the source model M_{S} then define the synaptic weights P between the neurons of consecutive layers. Examples of neural networks are illustrated in FIGS. 4 and 5.

In particular, FIG. 4 illustrates a neural network comprising an input layer C_{E} with 4 neurons, two intermediate layers Cᵢₙₜ with 6 and 5 neurons and an output layer C_{S} with 3 neurons. The synaptic weights P between the neurons of each layer are represented by arrows (only a reference P is illustrated so as not to overload the figure). In said example, each neuron of a layer takes the input thereof from the neurons of the preceding layer weighted by the synaptic weight P between said neuron and each neuron of the preceding layer.

FIG. 5 schematically illustrates neural networks having an input layer C_{E}, four intermediate layers Cᵢₙₜ and an output layer C_{S}.

The control method comprises a phase 110 of providing a model, called target model M_{C}, suitable for being trained on a target domain D_{C} for learning a target set of tasks T_{C}, aimed at controlling a given microgrid, called target microgrid 10C.

More particularly, the target model M_{C} was trained for determining an action Aₜ, from among the set E_{A} of predefined actions (e.g. described hereinabove), for controlling the target microgrid 10C, depending on the state Sₜ of the target microgrid 10C.

The target microgrid 10C is suitable for operating in a given environment, called target environment E_{C}, and according to a given operating mode, called target operating mode F_{C}. The target environment E_{C} delimits the target domain D_{C}. The target operating mode F_{C} delimits the target set of tasks T_{C}.

The target microgrid 10C differs from the source microgrid 10S in that:
the target environment E_{C} is different from the source environment E_{S}, which implies that the target domain D_{C} is different from the source domain D_{S}, and/or
the target operating mode F_{C} is different from the source operating mode F_{S}, which means that the target set of tasks T_{C} is different from the source set of tasks T_{S}.

The target model M_{C} comprises parameters w suitable for being optimized for the target domain D_{C} and the target set of tasks T_{C}. When the source model M_{S} is a neural network (see example above), the target model M_{C} is also a neural network comprising an input neural layer C_{E}, a layer of output neurons C_{S} and intermediate layers of neurons Cᵢₙₜ. The parameters w of the target model M_{C} then define the synaptic weights P between the neurons of consecutive layers.

The control method comprises a phase 120 of extraction of parameter values w from the source model M_{S}. The extraction phase 120 is implemented by the calculator 20 in interaction with the computer program product 22, i.e. is implemented by computer.

In one embodiment, the parameter values w extracted from the source model M_{S}, define at least the synaptic weights P between the neurons of the input layer C_{E} and of the intermediate layer Cᵢₙₜ of neurons consecutive to the input layer C_{E}, so-called first intermediate layer. Preferentially, the parameter values w extracted from the source model M_{S} also define the synaptic weights P between the neurons of a plurality of intermediate layers Cᵢₙₜ of neurons, consecutive to the first intermediate layer. In the example illustrated in FIG. 5, the extracted values are the values of the parameters w defining the synaptic weights P between all the layers except between the last intermediate layer Cᵢₙₜ and the output layer C_{S}.

The control method comprises a phase 130 of initialization of parameters w of the target model M_{C} with the parameter values w extracted from the source model M_{S}, so as to obtain an initialized target model M_{C}. The initialization phase 130 is implemented by the calculator 20 in interaction with the computer program product 22, i.e. is implemented by computer.

Thereby, when the models M_{S}, M_{C} are neural networks, the synaptic weights P between the layer neurons of the target model M_{C}, are initialized with the values of the synaptic weights P corresponding to said layers in the source model M_{S}. In the example illustrated in FIG. 5, only the synaptic weights P between the last intermediate layer Cᵢₙₜ and the output layer C_{S} are not initialized with the extracted values and are initialized randomly.

In one embodiment, at least one parameter w of the target model M_{C} which was initialized with an extracted value, is frozen. In one variant, the above applies to all parameters w of the target model M_{C} which were initialized with extracted values. In other words, the above means that the values of the parameters w cannot be subsequently modified, in particular during the optimization phase described hereinafter.

In a variant, all the parameters w of the target model M_{C}, even the initialized parameters, can be modified during the optimization step.

The control method comprises a phase 140 of optimization, depending on the target domain D_{C} and on the target set of tasks T_{C}, the parameters w of the target model M_{C} being initialized for obtaining a target model M_{C} trained for the control of the target microgrid 10C. The optimization phase 140 is implemented by the calculator 20 in interaction with the computer program product 22, i.e. is implemented by computer.

In one example, the optimization phase 140 comprises steps 140A of generation of training data and of steps 140B of training the target model M_{C} based on the generated training data. The generation 140A and training 140B steps are repeated in successive iterations.

During the 140A generation stages, a model to be trained (agent) interacts with an environment according to the principle of Deep Reinforcement Learning. The model to be trained is e.g. a neural network.

In particular, as illustrated in FIG. 6, the model to be trained M_{C} is suitable for determining an action Aₜ in response to a state Sₜ generated by a module, called environment E. The action Aₜ generated by the model M_{C} is suitable for being processed by the environment E. The environment E verifies that a set of constraints is satisfied during the execution of the action Aₜ and generates the following resulting state Sₜ₊₁ and a reward Rₜ. At least the data relating to the state Sₜ, to the determined action Aₜ, to the next state Sₜ₊₁ and to the reward Rₜ are stored in a memory M_{R} called “replay memory” intended for being subsequently used for training the target model M_{C}.

The replay memory M_{R} is typically initialized at startup, i.e. at the start of the very first generation step 100. Once the maximum capacity of the replay memory M_{R} is reached, the replay memory M_{R} then works e.g. according to the “First-In First-Out (FIFO)” model.

In the present case, the E environment was configured for simulating the operation of a target microgrid 10C. E.g. the simulation was carried out according to the principle of a Markovian decision process. The successive interactions between the target model M_{C} to be trained and the environment E will be used for obtaining a target model M_{C} trained for the control of a target microgrid 100.

An example of the implementation of the different steps of the generation phase is given hereinafter.

The step 140A aims to generate a set of training data depending on the target domain D_{C} and on the target set of tasks T_{C}.

The generation step 140A comprises a sub-step 140A-1 for the reception of initial data or of data coming from a preceding iteration. Such data are specific to the target domain D_{C}.

In an example of implementation, the data received, whether initial or coming from a preceding iteration, comprise a set of predetermined values of quantities of electrical energy to be exchanged P_{Net} and a set of possible initial values of quantity of electrical energy E_{Bcap} stored on the at least one electrical energy storage element 19.

The values of quantities of electrical energy to be exchanged P_{Net} were predetermined e. g. for each time step of a predefined period of time. The predefined period of time is e.g. one year and the time steps are one hour.

Each value of the quantity of electrical energy to be exchanged P_{Net} for a time step is e.g. the difference between the value of the electric energy P_{PV} produced by the at least one renewable energy production element 18 for said time step and the value of the electric energy demanded P_{L} by the at least one electric energy consumption element 14 for said time step. Thereby, one has:

P_{Net}(t)=P_{PV}(t)−P_{L}(t) (1)

The values of electric energy P_{PV} produced by the at least one renewable energy production element 18 and of electric energy P_{L} demanded by the at least one electric energy consumption element 14, were predetermined e.g. for each time step of the predefined period of time. Such values are e.g. derived from measurements carried out by sensors on existing installations or were randomly generated beforehand.

The possible initial values of the quantity of electrical energy initially stored E_{B}cap on the at least one electrical energy storage element 19, are predefined values. The possible values are e.g. 0 kilowatt hours (kWh), 5 kWh and 10 kWh.

In the same example of implementation, when the received data come from a preceding iteration, the received data comprise at least one of the following:
the following state Sₜ₊₁ obtained at the end of the preceding iteration,
an indication indicating whether the next state Sₜ₊₁ obtained at the end of the preceding iteration is a final state,
the current time step Δₜ of the preceding iteration, and
the model optimized during the last iteration. Such a model comprises parameters w which were optimized during the last iteration.

The generation step 140A comprises a sub-step 140A-2 of obtaining, from the received data, a current model suitable for determining an action Aₜ for controlling a microgrid 10C, among a set E_{A} of predefined actions, depending on a state Sₜ of the microgrid 10C.

In an example of implementation, the current model is the initialized target model received when the data are initial data and is, otherwise, the optimized model during the last iteration.

The set E_{A} of predefined actions is e.g. as defined above. The possible actions Aₜ are in particular set by the target set of tasks T_{C}.

The generation step 140A comprises a sub-step 140A-3 for determining, from the received data, a current time step Δₜ.

In an example of implementation, the current time step Δₜ is:
either an initialized time step Δₜ₀ when the data are initial data or when the indicator indicates that the next state Sₜ₊₁ obtained at the end of the preceding iteration is a final state. The initialized time step Δₜ₀ corresponds e.g. to the first time step of the predefined period of time on which the predetermined values of the quantity of electrical energy to be exchanged P_{Net} are defined.
or the preceding time step Δₜ₋₁ incremented by one unit when such a preceding time step Δₜ₋₁ exists and the next state Sₜ₊₁ obtained at the end of the preceding iteration is not a final state.

The generation step 140A comprises a sub-step 140A-4 for obtaining, from the received data, a current state Sₜ of a microgrid 10.

In one embodiment, the current state Sₜ is either an initial state S₀ when the current time step Δₜ is an initialized time step Δₜ₀, or a following state Sₜ₊₁ obtained during the last iteration.

When the current state Sₜ is an initial state S₀, the initial state S₀ is defined by the predetermined value of the quantity of electrical energy to be exchanged P_{Net} corresponding to the current time step (first time step Δₜ₀) and by a stored electrical energy quantity value E_{Bcap} chosen randomly from the set of possible values of quantity of electrical energy stored.

The generation step 140A comprises a sub-step 140A-5 of determination, by the current model, of an action Aₜ for controlling the microgrid 10 depending on the current state Sₜ according to a learning technique. The learning technique is e.g. a Q-Learning or a Double-Q-Learning technique, such as the Epsilon greedy technique.

The generation step 140A comprises a sub-step 140A-6 of verification that constraints predetermined by the action Aₜ determined depending on the current state Sₜ, are satisfied.

In one implementation mode, the predetermined constraints comprise at least one constraint selected from the following set of constraints:
a first constraint relating to the equilibrium between the sum of the quantity of electrical energy exchanged P_{B} by the at least one electrical energy storage element 19, the quantity of electrical energy P_{G} produced by the at least one fossil energy production element 16 and the quantity of electrical energy P_{C} consumed by the at least one electrical energy consumption element 14 (“load curtailment element”), and the quantity of electrical energy to be exchanged P_{Net}. The first constraint aims to satisfy the following equation:

P_{B}(t)+P_{G}(t)+P_{C}(t)=P_{Net}(t) (2)
a second constraint relating to the quantity of electrical energy E_{Bcap} stored on the at least one electrical energy storage element 19. The second constraint states that the quantity of stored electrical energy E_{Bcap} is comprised between predetermined limits.
a third constraint relating to the quantity of electrical energy P_{B} exchanged (either received or sent) by the at least one electrical energy storage element 19. The third constraint states that the quantity of exchanged electrical energy P_{B} is comprised between predetermined limits.
a fourth constraint relating to the operating mode of the at least one electrical energy storage element 19. The fourth constraint aims to satisfy the following equation:

E_{Bcap}(t)=E_{Bcap}(t−1)−P_{B}(t)·Δt (3)
a fifth constraint relating to the quantity of electrical energy P_{G} produced by the at least one fossil energy production element 16. The fifth constraint states that the quantity of produced electrical energy P_{G} is comprised between predetermined limits.

The generation step 140A comprises a sub-step 140A-7 of determination of a reward Rₜ representative of the operational cost induced following the execution of the action Aₜ and an indicator indicating whether the next state Sₜ₊₁ obtained following the execution of the action Aₜ is a final state.

The reward Rₜ is representative of the operational cost induced following the execution of the action Aₜ.

In one embodiment, the reward Rₜ determined for each training datum is equal to the quantity of electrical energy to be exchanged P_{Net} multiplied by a multiplicative coefficient selected from a set of multiplicative coefficients m, q, c depending on the action Aₜ determined. The multiplicative coefficients m, q, c represent the operational costs of at least one electrical energy storage element 19, of at least one fossil energy production element 16, and of the load curtailment, respectively.

For example, the reward Rₜ is equal to:
−m·P_{Net} if the determined action Aₜ is the charging or the discharging of the at least one electrical energy storage element 19 by a value equal to the quantity of electrical energy to be exchanged P_{Net}.
−q·P_{Net} if the determined action Aₜ is the production of a quantity of electric energy by the fossil energy storage element 16 of a value equal to the quantity of electric energy to be exchanged P_{Net}.
−(m·P_{NETBat}+q·P_{NetGen}) if the determined action Aₜ is the discharging of the at least one electric energy storage element 19 by a quantity of electric energy P_{NetBat} and the production of a quantity of electric energy P_{NetGen} by the fossil energy production element 16, with P_{NETBat}+P_{NetGen}=P_{Net}.
−e·P_{Net} if export of electrical energy towards an electrical energy distribution grid.
−i·P_{Net} if import of electrical energy from an electrical energy distribution grid.
−c·P_{Net} if the constraints are not satisfied.
0 if the determined action Aₜ is to not take any action.

In an example of implementation, the reward Rₜ is calculated depending on a cost function that is sought to be minimized. The goal is to obtain a trained model minimizing the operational costs of the target microgrid 10C while satisfying predetermined constraints over the period of time T. In one example, the costs induced by the at least one renewable energy production element 18 are not included in the cost function and a fixed cost is assumed for the at least one fossil energy production element 16 and the at least one electrical energy storage element 19. In the present example, the objective function is thereby, the sum of the cumulative costs for operating the at least one fossil energy production element 16 and the at least one electrical energy storage element 19 over the period of time T with a set time step (e.g. 1 hour). To simplify, it is assumed e.g. that the electrical power at time t is the power during the interval [t, t+Δt]. The cost function is then formulated as follows:

J_{obj}=Σₜ₌₀^{T}|P_{B}(t)|·m+|P_{G}(t)|·q+|P_{C}(t)|·c (4)

Where:
m, q and c represent the operational costs induced by the at least one electrical energy storage element 19, the at least one fossil energy production element 16, and the reduction in the power (“load curtailment”) of the at least one electrical energy consumption element 14
P_{B}(t) is the quantity of electrical energy exchanged by the at least one electrical energy storage element 19 (charged or discharged).
P_{G}(t) is the quantity of electrical energy produced by the at least one fossil energy production element 16.
P_{C}(t) is the reduction in the quantity of electrical energy required by the at least one electrical energy consumption element 14.

In an example of implementation, the indicator indicating whether the next state Sₜ₊₁ obtained following the execution of the action Aₜ is a final state, is determined depending on the current time step Δₜ and of the verification carried out in the preceding step. Thereby, the final state is e.g. reached:
when the current time step Δₜ is equal to a predetermined time step (e.g. the last time step of the predetermined values of quantities of electrical energy to be exchanged P_{Net} and when the constraints are verified, and
when the constraints are not verified (failure involving the return to an initial state).

When the current time step Δₜ is not equal to the predetermined time step and when the constraints are verified, the following state Sₜ₊₁ obtained is not a final state.

A learning datum comprising at least the current state Sₜ, the following state Sₜ₊₁, the determined action Aₜ and the reward Rₜ, then being stored in the replay memory M_{R}, and advantageously a Boolean variable indicating whether the following state obtained is or is not a final state.

The generation step 140A comprises the repetition of the preceding sub-steps (140A-1 to 140A-7 of the generation step 140A) as long as the indicator indicates that the next obtained state Sₜ₊₁ is different from a final state. The set of learning data stored until a final state is reached forms a learning set.

Once the final state is obtained, the training step 140B is started.

The training step 140B is a training phase of the current model wherein at least one parameter w of the current model is optimized based on at least one training set stored in the replay memory M_{R}, for obtaining an optimized model. The training technique used is e.g. based on a deep learning algorithm.

In one mode of implementation, only the non-frozen parameters w of the current model are optimized during the training step 140B.

Advantageously, the at least one parameter w of the model is optimized on the basis of a plurality of learning sets stored in the replay memory M_{R}.

The control method then comprises the repetition of the generation 140A and the training 140B steps until a convergence criterion is met, the model optimized during the last iteration being a model trained for the control of a target electrical microgrid 10C, also called control model.

For example, the convergence criterion is reached when, during a predetermined number of successive iterations, each time a final state is obtained, the current time step Δₜ which allowed the final state to be obtained, corresponds to a predetermined time step (e.g. the last time step of the predetermined values of quantities of electrical energy to be exchanged P_{Net}), and the sum of the rewards Rₜ obtained for each training datum of the corresponding training set, being greater than or equal to a predetermined threshold. Thereby, when the convergence criterion is reached, it is considered that the cost function is minimized.

The control method comprises a phase 150 of use of the control model comprising the determination of a control action Aₜ of the target microgrid 10C following the reception, by the control model, of the current state Sₜ of the target microgrid 10.

A person skilled in the art will understand that the control model was first validated in a conventional manner on test data different from the data of the training set, before being used for the effective control of a target microgrid 10C. The validation consists e.g. in the implementation of the generation step 140A with different input data.

The control method comprises a phase 160 of carrying out the action Aₜ determined by sending commands to the elements of the target microgrid 10C. The commands are e.g. commands for connecting or disconnecting the elements of the target microgrid 10C of the electrical energy transmission grid 12 and/or commands for charging, discharging or producing electrical energy. Depending on the case, an Aₜ action can also be the absence of commands (corresponding to the action of not doing anything).

Thereby, the control model obtained following the implementation of the present method minimizes the operational costs of the microgrid. Such a model also dispenses with a prediction module. Same can thus be easily adapted to all types of microgrid.

Furthermore, such a control model is obtained more quickly since data resulting from the learning of another model are reused. The present method thereby offers the possibility of leveraging on learning carried by other models for microgrids having different environments and/or operating modes.

The present method is thereby perfectly suited for being implemented in a large number of microgrids since the time required for obtaining an optimized model is significantly reduced.

A person skilled in the art will understand that the embodiments and variants described above can be combined so as to form new embodiments provided that same are technically compatible.

1. A method for controlling at least one electrical microgrid, each electrical microgrid comprising at least one electrical energy consumption element, at least one electrical energy production element and at least one electrical energy storage element, each microgrid being suitable for assuming a plurality of energy states, each energy state being defined by a quantity of electrical energy to be exchanged between elements of the microgrid and by a quantity of stored electrical energy on the at least one electrical energy storage element, each microgrid being apt to switch from one state to another by the implementation of an action on the microgrid among a set of predefined actions, the method comprising the phases of:
a. supplying a source model trained on a source domain for learning a source set of tasks, so that the source model is suitable for determining an action, among the set of predefined actions for controlling a given microgrid, called source microgrid, depending on the state of the source microgrid, the source microgrid being suitable for operating in a given environment, called source environment, delimiting the source domain, the source microgrid being suitable for operating according to a given operating mode, called source operating mode, delimiting the source set of tasks, the source model comprising parameters the values of which are optimized for the source domain and the task source assembly,
b. supplying a target model suitable for training on a target domain for learning a target set of tasks, so that the target model is suitable for determining an action, among the set of predefined actions, for controlling a given microgrid called target microgrid, depending on the state of the target microgrid, the target microgrid being suitable for operating in a given environment called target environment, delimiting the target domain, the target microgrid being suitable for operating according to a given operating mode called target operating mode, delimiting the target set of tasks, the target environment and the target operating mode being such that the target domain is different from the source domain and/or the target set of tasks is different from the source set of tasks, the target model comprising parameters,
c. extracting parameter values from the source model, the extraction phase being implemented by computer,
d. initializing parameters of the target model with the parameter values extracted from the source model, for obtaining an initialized target model, the initialization phase being implemented by computer, and
e. optimizing, according to the target domain and the target set of tasks, of the parameters of the target model initialized for obtaining a target model trained for the control of the target microgrid, the optimization phase being implemented by computer.

2. The method according to claim 1, wherein at least one parameter value of the target model which was initialized with the extracted values, is frozen during the optimization step.

3. The method according to claim 1, wherein each model is a neural network comprising an input neural layer, an output neural layer and intermediate neural layers, the parameters of each model defining the synaptic weights between the neurons of consecutive layers, the parameter values extracted from the source model corresponding at least to the synaptic weights between the neurons of the input layer and the neurons of the intermediate layer consecutive to the input layer, called first intermediate layer, and, furthermore, preferentially, the synaptic weights between the neurons of a plurality of intermediate layers of neurons, consecutive to the first intermediate layer of neurons.

4. The method according to claim 1, wherein the optimizing phase comprises:
a. generating training date sets depending on the target domain and on the target set of tasks,
b. training the target model wherein at least one parameter of the target model is optimized based on at least one training set generated for obtaining an optimized target model, and
c. repeating the generation and training steps until a convergence criterion is satisfied, the target model optimized during the last iteration being a target model trained for the control of the target microgrid.

5. The method according to claim 1, wherein the method comprises:
a. a phase of using the trained target model comprising the determination of an action of control of the target microgrid following the reception, by the training target model, of the current state of the target microgrid, and
b. a phase of carrying out the action determined by sending commands to the elements of the target microgrid.

6. The method according to claim 1, wherein the predefined operating modes comprise at least the following operating modes:
a. a so-called isolated operating mode wherein the microgrid is disconnected from the electrical power distribution grid,
b. a so-called connected operating mode wherein the microgrid is connected to an electrical power distribution grid, and
c. a so-called intermediate operating mode wherein the microgrid is connected to an electrical energy distribution grid or is isolated from the electrical energy distribution grid depending on the time step considered.

7. The method according to claim 1, wherein each microgrid comprises at least one renewable energy production element and at least one fossil energy production element, the quantity of electrical energy to be exchanged being the difference between the quantity of electric energy produced by the at least one renewable energy producing element and the quantity of electric energy demanded by the at least one electric energy consumption element, the quantity of electric energy to be exchanged being a quantity of electrical energy to be exchanged between the elements of the microgrid with the exception of the at least one renewable energy production element.

8. The method according to claim 1, wherein for two microgrids working in distinct environments,
a. distributing the quantity of electric power produced by the at least one renewable energy production element of one of the microgrids over a predetermined period is different from the distribution of the quantity of electric power generated by the at least one renewable energy production element of the other microgrid over the predetermined period, and/or
b. distributing the quantity of electrical energy demanded by the at least one electrical energy consumption element of one of the microgrids over a predetermined period being different from the distribution of the quantity of electrical energy demanded by the at least one electric power consumption element of the other microgrid over the predetermined period.

9. The method according to claim 1, wherein the set of predefined actions comprises at least one of the following actions:
a. discharging the at least one electrical energy storage element by a quantity corresponding to the quantity of electrical energy to be exchanged, or when the quantity of electrical energy stored on the at least one electrical energy storage element is insufficient with regard to the quantity of electrical energy to be exchanged, the full discharge of the at least one electrical energy storage element and the supply of the remaining quantity of electrical energy by the at least one electrical energy production element,
b. charging the at least one electrical energy storage element by a value corresponding to the quantity of electrical energy to be exchanged,
c. producing a quantity of electrical energy corresponding to the quantity of electrical energy to be exchanged by the at least one electrical energy production element,
d. importing electrical energy from an electrical energy distribution grid, so as to supply at least part of the quantity of the electrical energy to be exchanged,
e. exporting at least a part of the quantity of electrical energy to be exchanged to an electrical energy distribution grid,
f. importing the quantity of electrical energy to be exchanged from an electrical energy distribution grid and a quantity of electrical energy for charging the electrical energy storage element, and
g. not taking any action.

10. A non-transitory computer-readable storage medium comprising a computer program product being loadable on a data processing unit and causing execution of a method according to claim 1 when the computer program is implemented on the data processing unit.
